(19) United States
(12) Patent Application Publication
(10) Pub. No.: US 2026/0297881 A1
(43) Pub. Date: Oct. 1, 2026

(54) PILE STRUCTURE FOR AN OFFSHORE WIND TURBINE AND METHODS OF INSTALLING THE SAME

(71) Applicant: EQUINOR ENERGY AS, Stavanger (NO)

(72) Inventors: Tor-Inge YETGINER-TJELTA, Stavanger (NO); Etienne ALDERLIESTE, Blommenholm (NL)

(21) Appl. No.: 19/111,848

(22) PCT Filed: Apr. 18, 2023
(86) PCT No.: PCT/NO2023/050087

§ 371 Date: Mar. 14, 2025

(30) Foreign Application Priority Data
Sep. 15, 2022 (GB) 2213571.9

(51) Int. Cl. E02D 13/00; E02D 5/28; E02D 7/06; E02D 27/42; E02D 27/52; F03D 13/25

(52) U.S. Cl. CPC E02D 13/00; E02D 5/285; E02D 7/06; E02D 27/425; E02D 27/525; F03D 13/25; F05B 2240/95

(57) ABSTRACT

Disclosed herein are pile structures for offshore wind turbines and method of installing the same. A pile structure (100) comprises: a pile body (101) having a pile tip (101a) configured to be inserted into a soil body (5) such as a seabed; and a fluid delivery apparatus (110) configured to deliver a fluid to a surface of the pile body (101) proximate to the pile tip (101a) in a direction extending aware from the pile tip (101a). The fluid delivery apparatus (110) is configured to deliver the fluid at a local differential pressure of between 0 and 8 bar, i.e. at a low pressure.

The present invention relates to pile structures, particularly, but not exclusively, for offshore wind turbines, and methods of installing the same.

Offshore wind turbines may be broadly separated into two different classifications: floating wind turbines and bottom-fixed offshore wind turbines (Jiang, Z. (2021) “Installation of offshore wind turbines: A technical review”, Renewable and Sustainable Energy Reviews, Vol. 139).

Floating wind turbines comprise a floating platform, for example a spar platform, a semisubmersible platform or a tension leg platform, held in place by a number of mooring lines. The tower of the wind turbine is mounted to the platform.

Bottom-fixed offshore wind turbines maintain direct contact between the wind turbine structure and the seabed. Such examples include gravity base foundations, which use their own weight to resist any lateral forces acting on the wind turbine, suction bucket anchors and piles. Suction bucket anchors and piles both require insertion into the seabed, and utilise a contact force between their lateral surfaces and the seabed to resist any lateral forces acting on the wind turbine.

Suction bucket anchors are large caisson or tank-type structures that are installed into the seabed using a pump. The pump is arranged to discharge water from the caisson structure, such that the caisson structure is forced or ‘sucked’ into the seabed by the resulting pressure differential. The suction bucket anchor may then act as a mono-bucket foundation, or as part of a multi-bucket foundation in combination with a jacket structure.

In contrast, piles are structures of elongate form, driven into a soil body such as, but not limited to, the seabed using a hammering procedure. Pile structures can be tubular or columnar, or can be sheet piles or H piles. The hammering procedure uses a pile driving hammer, or impact hammer, to drive the pile into the seabed. Forces of up to 50 or 100 times the force of gravity may be generated during pile driving, and accordingly pile structures must be able to withstand these forces. The pile is installed upright to provide the greatest lateral frictional support between the pile and the seabed. The pile may act as a monopile foundation, or may form part of a multi-pile foundation in combination with a jacket structure.

Piles are competitive foundation solutions for installing offshore wind turbines, as they are simple in their construction and installation.

However, noise is generated during pile driving owing to the impact of the hammer on the pile. Noise generated by pile driving is broadband and the noise generated may exceed several hundred decibels (dB) in the surrounding region. The generation of such noise may be problematic for marine life, and as such there are various regulations to limit the amount of noise generated during pile driving.

The noise generated during pile driving may be mitigated using various sound-damping solutions (see table 4 of Jiang, Z.). However, such solutions increase the cost of installation for piles, and there is variable experience with their efficacy.

The amount of noise generated may also be reduced by using weaker forces during pile driving. However, larger pile structures (which may be used to support offshore wind turbines of greater size and/or in deeper seas) require greater force to successfully install them.

Various seabed soils may also pose a problem during installation of piles. For example, soils comprising glauconite may require greater forces during pile driving to overcome the high shear strengths glauconitic soils characteristically exhibit upon insertion of the pile into the soil. Accordingly, there may be offshore locations where pile installation is not currently feasible, due to the high resistive forces exhibited by the soil during insertion. This is because the high resistive forces may require the use of pile driving hammers that are larger and thus not cost efficient and/or thus generate noise that is louder than desired for use in proximity to marine life.

Processes such as ‘jetting’ may also be used to assist with the insertion of suction bucket foundations, and indeed pile structures used in other contexts, into the seabed during pile driving. Jetting generally involves the removal of soil from beneath the pile tip by spraying jets of water directly into the soil, in a direction of insertion of the pile (Cathie et al. (2019) “Suction Installed Caisson Foundations for Offshore Wind: Design Guidelines”, Offshore Wind Accelerator, February, page 56). Jetting requires high flow rates and pressures. Pressures typically associated with jetting are high, and may be in the order of 10 bar (1000 kPa) to 100 bar (10 MPa) relative to the pressure at the jetting location. Whilst jetting may assist in easing insertion of pile structures by removing soil from below the pile tip, the removal of soil weakens the structure of the seabed formation into which the pile structure is installed. This reduces the resistance of the formation to lateral loads and thus weakens the lateral load capacity of the installed pile structure. As such, the use of jetting is generally avoided when installing pile structures for offshore wind turbines.

Accordingly, there exist practical limitations as to the size of pile structures used for offshore wind turbines, and drawbacks associated with using larger pile structures for offshore wind turbines, particularly when used in certain types of seabed formation. It is desirable to address and/or overcome the above-mentioned limitations.

Viewed from a first aspect of the present invention, there is provided a pile structure comprising: a pile body having a pile tip configured to be inserted into a soil body; and a fluid delivery apparatus configured to deliver a fluid to a surface of the pile body proximate to the pile tip in a direction extending away from the pile tip. In preferred embodiments, the fluid delivery apparatus is configured to deliver the fluid to the surface of the pile body at a local differential pressure of between 0 and 8 bar.

Thus, the present invention concerns the supply of liquid at a relatively low pressure compared to that used for jetting because (as will be explained below) it serves a somewhat different purpose. Indeed, as will be discussed further, still lower pressures are preferred for many applications. Accordingly, viewed from a second aspect of the present invention, there is provided a pile structure comprising: a pile body having a pile tip configured to be inserted into a soil body; and a fluid delivery apparatus configured to deliver a fluid to a surface of the pile body proximate to the pile tip at a local differential pressure of between 0 and 8 bar (0 and 800 kPa). In preferred embodiments, the fluid delivery apparatus is configured to deliver the fluid to the surface of the pile body at a local differential pressure of between 0 and 5 bar (0 and 500 kPa).

For the avoidance of doubt, the term “local differential pressure” as used herein refers to the pressure of the delivered fluid compared to the ambient pressure at the location of the pile tip. As such, the absolute pressure increases with depth where the soil body is a seabed, for example, or depending on the water table of the soil.

By delivering fluid proximate to the pile tip of the pile body, the fluid delivery apparatus may act to reduce any effective stresses and/or resistive forces experienced by the pile body during its insertion into the soil body (e.g. frictional forces acting between the soil of the soil body and the pile wall). This is achieved because the fluid delivery apparatus acts to reduce the experienced effective stresses and/or resistive forces experienced by the pile body during its insertion into the soil body by a plurality of mechanisms. However, because the fluid is delivered at relatively low pressure and/or in a direction away from the pile tip (i.e. generally opposite the direction of insertion), it is not a form of jetting.

As will be discussed further below, the invention is particularly useful for piles used to support offshore wind turbines.

In clay and soils comprising a significant percentage of clay and/or exhibiting clay-like properties, the delivered fluid may particularly reduce the undrained shear strength at the soil/pile structure interface. Accordingly, the driving force required to successfully install the pile structure in the soil body may be reduced, meaning that an amount of noise generated during installation may be reduced and/or a smaller pile driving apparatus, such as a pile driving hammer or impact hammer, may be used, relative to the size of the pile structure. From another perspective, as less energy is required to motivate the pile structure into the soil body, larger pile structures may be installed in the soil body relative to the required pile driving force.

Additionally, as less energy may be required to motivate the pile structure into the soil body, the present invention may better facilitate the use of alternative pile driving tools such as vibratory hammers, or other pile driving tools, that generate lower levels of noise during use.

The delivered fluid may act to lubricate the surface of the pile body. This may reduce the frictional forces experienced by the pile body during insertion into the soil body. As such, the fluid delivery apparatus may act to reduce the experienced effective stresses and/or resistive forces experienced by the pile body during its insertion into the soil body by a plurality of mechanisms.

Additionally, the delivered fluid may act to reduce effective stresses in various soils of the soil body that may resist penetration of the pile tip.

For example, soil layers containing clays may exhibit high effective stresses. The delivery of fluid to these clays may result in mixing of the clays and the fluid, causing the clay locally to plasticise further beyond the remoulded shear strength and thus be less resistive to insertion of the pile body. Additionally, the plasticised clay with an increased water content may form a lubricating layer on the surface of the pile body, thus reducing any frictional forces experienced by the pile body during its insertion into the soil body.

As well as soil layers containing clays, soil layers containing glauconite (e.g. glauconitic sands) may also exhibit increased resistance to the penetration of the pile tip into the soil body. Glauconite, along with some clays, may react to the insertion of objects (such as the pile tip of the pile body) by developing a localised negative pore water pressure. This negative pore pressure develops as a result of low permeability of the sediment, and increases the shear strength of the sediment. By adding fluid to the sediment during insertion of the pile body, the negative pore pressure of the material may be made less negative or become positive (i.e. exhibit an excess pore pressure) and the shear strength of the sediment reduced. This can reduce the driving force required to insert the pile body into such soil layers. As these regions of high negative pore pressure also tend to develop in close proximity to the pile body (e.g. within a few centimetres from the pile body), delivery of the fluid to the surface of the pile body is sufficient to reduce the shear strength of these soil layers.

The pile structure may have particular utility in the field of offshore wind turbines. By reducing the frictional forces experienced during insertion, the pile structure (e.g. for offshore wind turbines) may provide a foundation structure that is less disruptive to marine life during installation; enable foundation structures for wind turbines to be more easily installed in soil locations comprising glauconite and/or high strength clays, thus increasing the available offshore locations suitable for installing offshore wind turbines; and enable larger pile structures to be used, thus facilitating the installation of larger offshore wind turbines that may be capable of generating greater power. The pile structure may be an offshore pile structure.

The soil body is a body of soil comprising one or more soil layers. The soil body may be an onshore or an offshore soil body. The soil body may be a seabed.

For the pile structure as described in the first aspect, by also delivering the fluid in a direction extending away from the pile tip, the fluid may be more efficiently applied to the surface of the pile body to lubricate it. Having the fluid be delivered in a direction opposite to the direction of insertion of the pile structure also reduces a likelihood of the delivery of fluid from the fluid delivery apparatus being impeded by soil from the soil body.

The direction extending away from the pile tip may be regarded as a direction extending away from the pile tip and towards the pile head; and/or a direction extending opposite to a direction of insertion of the pile structure into the soil body. However, it will be appreciated that the fluid does not all have to be delivered precisely in this direction; the invention merely requires that a sufficient amount of the fluid is delivered generally in the stated direction so that it is delivered proximate the side wall of the pile above the delivery apparatus. Nevertheless, in preferred forms of the invention, fluid usage is optimised by delivering it via apertures or nozzles oriented substantially in the stated direction, and/or through the aid of filters.

The fluid delivery apparatus of the second aspect may also be configured to deliver the fluid in a direction extending away from the pile tip. The pile structure of the second aspect may therefore also benefit from the aforementioned technical advantage where such a feature is present.

For the pile structure as described in the second aspect, by also delivering fluid (i.e. providing lubrication) to the pile body at a low differential pressure, disturbance of the soil of the soil body owing to the flow of fluid may be reduced during insertion of the pile in the soil body. Accordingly, upon installation of the pile structure, the soil body may be able effectively to provide lateral support to the pile structure and hence improve the stability of the installation. This is in direct contrast to fluids injected into the soil body during jetting, which are often ejected at pressures of 10 bar to 100 bar (1 MPa to 10 MPa) or more which may substantially weaken the soil body formation.

As noted above, the fluid delivery apparatus provides lubrication, whilst minimising any effect on the strength of the surrounding foundation. Accordingly, the fluid is preferably delivered at the lowest pressure that is sufficient to deliver it. Accordingly, the absolute pressure will depend upon the conditions at the site where it is delivered, such as the local formation pressure or the pressure at or below the soil body, such as the seabed (e.g. towards the pile tip, in the region where the fluid is delivered). Therefore, the fluid delivery apparatus is configured to deliver the fluid at a pressure between 0 and 8 bar (0 and 800 kPa); preferably between 0 and 5 bar (0 and 500 kPa) or more preferably between 0 and 3 bar (0 and 300 kPa), wherein this pressure is a differential pressure relative to the local ambient pressure. The fluid delivery apparatus may be configured to deliver the fluid at a pressure of at least 0.1 bar (10 kPa), at least 0.2 bar (20 kPa), at least 0.5 bar (50 kPa), or of at least 1 bar (100 kPa). Said local differential pressures may define a lower limit of any of the aforementioned ranges.

The fluid delivery apparatus may be configured to be driven by a hydrostatic pressure head, so that it is supplied under gravity. Thus, a body of fluid may be provided with a sufficient head and in flow communication with the fluid delivery apparatus. This may be regarded as a first/passive mode of operation. The use of a hydrostatic pressure head may be sufficient due to the purpose of the fluid delivery being predominantly that of lubricating the pile body. The body of fluid may be located internally of the pile body and is preferably provided in the body itself (i.e. no tank or the like is required). The body of fluid may have a height (i.e. head) greater than the surrounding sea level. The body of fluid is preferably a body of seawater.

Where necessary, however, for example, in applications where higher pressure is needed to ensure fluid delivery, the fluid delivery apparatus may be configured to be driven by a pump in flow communication with the fluid delivery apparatus. This may be regarded as a second/active mode of operation. The pump may be a submersible pump or it may be a pump provided on a nearby vessel.

The fluid delivery apparatus may be configured to switch between the first mode of operation and the second mode of operation.

The pile structure may be suitable for an offshore structure and/or offshore equipment. For example, the pile structure may be suitable for an offshore platform, and may be configured to be inserted or installed in a seabed. Whilst the invention may be applied in numerous situations, the pile structure may in particular be suitable for supporting an offshore wind turbine. In this regard, it may form a monopile supporting a wind turbine, or form part of a pile pin structure in a multi-pile jacket structure.

The distal end of the pile body is referred to herein as the pile tip. The section of the pile body located between the pile tip and the pile head (i.e. a proximal end of the pile body) is referred to as the central section. The pile tip and/or the pile head may be a generally blunt of planar surface, and may be located perpendicular to the surface of the pile body.

In some arrangements, the pile body may be a sheet pile body, a H-pile body, or a solid columnar pile body.

In other arrangements, the pile body may be a tubular pile body, i.e. a pile body of tubular structure or form. The pile body may comprise an internal surface and an external surface, defined relative to the surfaces of the tubular structure.

The pile body may be circular, elliptical, annular or polygonal in cross-section.

The pile body may be a generally cylindrical tubular structure, and may be formed of steel, such as steel grade S355. The pile tip is open, i.e. annular in cross-section. The pile head may also be open or it may be closed, i.e. forming a disc.

The global diameter of the pile body may be at least 2 m wide, 5 m wide, 8 m wide, 10 m wide or more. If the pile structure is a pin pile structure, e.g. to be used for mounting a leg of a jacket structure, the global diameter may be less than 5 m, or less than 3 m. If the pile structure is a monopile structure, the global diameter may be at least 5 m, at least 8 m, or at least 10 m. The diameter of the pile structure may be based on a number of factors, including: the depth of the sea where the pile structure is to be installed; or the size of the equipment to be mounted to the pile structure.

The pile body is preferably tapered at the top. This may facilitate driving of the pile structure, e.g. by a pile driving hammer. A central section of the pile body is preferably constant in external diameter.

In some embodiments, the pile body may be formed of multiple sections, or ‘cans’, welded together. Each section may be at least 2 m, 3 m, 4 m, or 5 m in height.

The thickness of a wall of the pile body may vary along its length. Varying the thickness of the pile body in this manner may minimise stresses and/or fatigue experienced by the pile body during driving. The wall may become progressively thicker along the length of the pile body extending from the pile head to the pile tip. In some arrangements, the pile body may be at its thickest towards the central section of the pile body, before tapering again towards the pile tip. The pile body may be at its thickest, or become thicker again, at the lowermost section of the pile body (i.e. at the pile tip). This may resist buckling and/or ovalisation of the pile body during driving.

The thickest section of the pile body, which may also be the lowest section of the pile body, may have a wall thickness of between 100 to 120 mm thick. The thinnest section of the pile body, which may also be the highest section of the pile body, may have a wall thickness of 50 to 70 mm thick.

The pile body may be between 20 to 100 m long, between 30 to 90 m long, between 40 to 80 m long, or between 50 to 70 m long. The pile body may be configured to be embedded in a seabed to a depth of at least 10 m, at least 20 m, at least 30 m, or at least 40 m. The pile body may be configured to project above the seabed by at least 3 m, at least 45 m 10 m, 20 m, at least 30 m, at least 40 m, at least 50 m, or at least 60 m.

The pile body may comprise a releasable hatch. The hatch is fluid-tight when closed. The hatch may enable access to the interior of the pile structure. The hatch is arranged to be above a seabed upon installation of the pile structure in the seabed.

Water may be used as the fluid. More particularly, seawater may be used as the fluid, such as when the pile structure is configured to be installed in the seabed. Where water/seawater is used as the fluid, the fluid delivery apparatus may be regarded as a water delivery apparatus. Other fluids are contemplated, however. For example, the fluid may be, or comprise, bentonite mud. Bentonite mud may be of particular use in sandy soils.

Preferably, the fluid delivery apparatus is located substantially at, i.e. immediately behind, the pile tip. As the pile tip may experience the greatest resistive forces during driving of the pile body, locating the fluid delivery apparatus at the tip may provide the greatest effect in reducing any frictional forces/effective stresses experienced during insertion.

The fluid delivery apparatus may be configured to deliver the fluid to an external surface and/or an internal surface of the pile body.

The fluid delivery apparatus may comprise a manifold having one or more (i.e. one or a plurality of) apertures configured to deliver the fluid.

The manifold may extend around the pile body. The manifold may encircle the pile body, or extend circumferentially around the pile body.

The manifold may comprise an upper surface and a side surface. As discussed further below, a driving shoe (i.e. a reinforcing element at the lower end of the pile) may be provided. The pile body and the driving shoe may form a further side surface and a lower surface, respectively. Alternatively, the manifold may comprise an integrally formed further side surface and lower surface.

The manifold may define a plenum extending around the pile body. Where the pile body is cylindrical, elliptical or annular in cross-section, the manifold may be an annular member (such as an annular ring member) defining a plenum extending circumferentially with respect to the pile body. Where the pile body is a sheet pile body or a H-pile body, the manifold may extend along or around a perimeter of the pile body.

The plenum is arranged to receive a flow of the fluid. The plenum is thus configured to convey a flow of the fluid that is to be delivered to the surface of the pile body.

In other words, the manifold may define a cavity arranged to receive a flow of fluid, the manifold also having one or more apertures each configured to deliver a flow of the fluid out of the cavity and to a surface of the pile body.

The one or more apertures may be a plurality of apertures.

The plurality of apertures may comprise a plurality of nozzles, holes or outlets. The apertures are generally configured to direct a flow of the fluid delivered from the fluid delivery apparatus. The plurality of apertures may be formed in the upper surface of the manifold, i.e. in a surface facing away from the pile tip. Accordingly, the apertures may be arranged such that they are configured to deliver the flow of fluid in the direction extending away from the pile tip. Of additional benefit, the plurality of apertures may thus be formed in a surface that is not facing in a direction of insertion of the pile body. As such, the apertures may be less susceptible to becoming blocked or impeded by soil during insertion of the pile body.

Each aperture may have a diameter of at least 1 mm, at least 2 mm, at least 3 mm, at least 4 mm, or at least 5 mm. Preferably, each aperture has a diameter of between 1 to 3 mm.

The plurality of apertures is preferably distributed circumferentially, and further preferably evenly, around the manifold. Each aperture may have a spacing of about 5 mm, or of between 3 and 10 mm. The apertures may have a spacing of less than 10 mm, less than 20 mm, less than 30 mm, less than 40 mm, or less than 50 mm.

Alternatively, each aperture may have a spacing of between 20 and 50 mm. The apertures may have a spacing of at least 20 mm, at least 30 mm, at least 40 mm or at least 50 mm.

The apertures may be formed during manufacture of the manifold, e.g. during casting, or may be formed by drilling and/or cutting of the manifold post-fabrication.

The one or more apertures may comprise a single continuous aperture.

The single continuous aperture encircles or surrounds part of or the entirety of the pile body, i.e. it is continuous. The single continuous aperture may be an annular slit or channel formed in an upper surface of the manifold.

By providing a single continuous aperture circumferentially surrounding the wall of the pile structure, fluid may be more evenly and completely delivered to the surface of the pile body proximate to the pile tip, since the single continuous aperture is not interrupted by other elements such as the surface of the manifold or the like. This arrangement may facilitate lubrication of the surface of the pile body.

Alternatively, the one or more apertures may comprise a plurality of apertures wherein each aperture is an elongate slit or opening extending around the pile body. Each aperture may surround substantially at least a tenth, at least a sixth, at least a fifth, at least a quarter, at least a third or at least a half of the circumference of pile body. Each of the one or more apertures may provide an arrangement that reduces the number of interruptions, or gaps, separating the apertures. Such and arrangement may result in fluid being more evenly and completely delivered to the surface of the pile body proximate to the pile tip.

The fluid delivery apparatus may further comprise one or more filters occupying the one or more apertures. The filters are configured to be permeable to the fluid, and are selected to be as impermeable to soil without being of detriment to the flow of the fluid, i.e. such that the filters are configured to prevent an ingress of soil into the manifold but still enable a flow of fluid across them. The filters preferably match the size and shape of the one or more apertures such that the apertures are completely occupied by the filter. The filters may be each termed a first filter, simply for ease of reference.

Each first filter occupies a respective aperture. The one or more first filters may be of particular utility where the one or more apertures comprises a single continuous aperture or wherein each aperture is an elongate slit. Where the one or more apertures comprises a single continuous aperture, preferably the one or more first filters comprise a single continuous filter occupying the single continuous aperture.

By placing first filters in the one or more apertures, water can still be delivered from the fluid delivery apparatus but the ingress of soil into the fluid delivery apparatus is prevented.

The first filter is configured to be as impermeable to soil without being of detriment to the flow of fluid as described above, and may therefore be configured to be impermeable to particulate matter above a predetermined grain size.

The first filter may be one of a sand-epoxy filter, a Vyon filter or a geotextile filter. The filter may comprise one or more layers, with each layer comprising woven or non-woven materials. The filter may comprise a volume element or layer and a covering layer. The volume element may primarily promote a flow of fluid, and the covering layer may primarily impede a flow of soil or sediment. The permeability of the first filter may be selected depending on a predetermined pressure for delivering the fluid and a predetermined flow rate of fluid from the fluid delivery apparatus.

The fluid delivery apparatus may further comprise a filter configured to extend from the manifold in a direction opposite to the direction of insertion of the pile tip. The filter is configured to be as impermeable to soil as possible without being of detriment to the flow of fluid, and permeable to the fluid. The filter may therefore be configured to be impermeable to particulate matter above a predetermined grain size. This filter may be termed a second filter simply for ease of reference.

The second filter may promote the flow of fluid along the surface of the pile body. For example, the second filter may be arranged to, in use, channel fluid along the surface of the pile body proximate to the pile tip.

Additionally, the second filter may facilitate the delivery of fluid to any soil near to the surface of the pile body proximate to the pile tip. For example, during insertion of the pile structure, a cavity or an overhang of soil may form behind the manifold. The second filter may improve contact between the pile structure and the adjacent soil such that fluid is effectively delivered to the interface between the soil and the pile structure. This may be particularly beneficial when the pile tip is located in soils of negative pore water pressure.

The second filter may be fixed to the manifold using glue, a weld joint or a combination of the two.

The second filter may be a geotextile filter defining a skirt extending from the manifold, wherein the one or more apertures are located between the skirt and the pile body. The geotextile filter may be a reinforced geotextile membrane. The skirt may also be regarded as a collar. The geotextile filter may comprise one or more layers, with each layer comprising woven or non-woven materials. The filter may comprise a volume element or layer and a covering layer. The volume element may primarily promote a flow of fluid, and the covering layer may primarily impede a flow of soil or sediment.

The geotextile filter can be considered to comprise a first end and a second end. The first end is fixed to the manifold, for example towards an edge of the manifold distal to the pile body. The second end is a free end extending downstream of the one or more apertures. In some arrangements, the free end is not fixed to the surface of the pile body at all, i.e. the free end is free along its entirety. In other arrangements, the second end is intermittently or periodically fixed to the surface of the pile body proximal to the pile tip. The free end may be fixed at intervals of between 5 to 30 cm, and/or at intervals of at least every 5 cm, at least every 10 cm, at least every 15 cm, at least every 20 cm, or at least every 25 cm, such that the free end is intermittently free or not fixed.

The geotextile filter may be reinforced, and/or it may be a deformable fabric. The geotextile filter may be configured to trail in a direction opposite to the direction of the pile body during insertion of the pile body.

The shape of the skirt may promote the flow of fluid along the surface of the pile body, whilst also providing an interface for delivering fluid to any soil in contact with the skirt. This may be particularly beneficial when the pile tip is located in soils of negative pore water pressure. The geotextile filter may also serve to prevent soil from occupying the space directly downstream of the one or more apertures to maintain proper functioning of the fluid delivery apparatus.

Alternatively, the second filter may define a pitched surface extending between the manifold and the pile body, wherein the one or more apertures are covered by the geotextile fabric filter. The second filter may be a geotextile filter, a Vyon filter or a sand-epoxy filter. The filter may comprise one or more layers, with each layer comprising woven or non-woven materials. The filter may comprise a volume element or layer and a covering layer. The volume element may primarily promote a flow of fluid, and the covering layer may primarily impede a flow of soil or sediment.

The pitched surface may cover the one or more apertures, such that the ingress of soil into the one or more apertures. The pitched surface may provide a surface in contact with the surrounding soil, such that fluid is effectively delivered to the soil as well as to the surface of the pile body. This may be particularly beneficial when the pile tip is located in soils of negative pore water pressure.

The pitched surface may define a volume between the second filter, the manifold and the pile body downstream of the one or more apertures. Fluid may be promoted to flow along the surface of the pile body during insertion of the pile body, e.g. by one or more of a wicking action of the second filter or a motion of the pile body during insertion. In such arrangements, the second filter may preferably be a geotextile filter, such as a geotextile membrane or fabric, of elongate form.

Alternatively, the second filter may comprise a tapered cross-section and may sit flush to both the pile body and to an upper surface of the manifold. That is, the second filter may extend between the pile body and the manifold, and extend along each of the surface of the pile body and the manifold.

The manifold may be configured to receive a flow of the fluid via a channel formed through the pile body. That is, the manifold may be configured to receive a flow of the fluid from a conduit located on an opposite side of the pile body to the manifold. The pile body may comprise a plurality of said channels formed therethrough.

Additionally or alternatively, the manifold may be configured to receive a flow of the fluid via an opening formed in a surface of the manifold facing away from the pile tip. That is, the manifold may be configured to receive a flow of the fluid from a conduit located on the same side of the pile body as the manifold. The manifold may comprise a plurality of said openings, distributed circumferentially around the manifold. The openings may be distributed intermittently, or coincidentally with, the one or more apertures.

The manifold may extend circumferentially around an external surface of the pile body, with the one or more apertures being configured to deliver the fluid to the external surface of the pile body. That is, the manifold may be regarded as an external manifold, relative to the pile body.

Alternatively, the manifold may extend circumferentially around an internal surface of the pile body, with the one or more apertures being configured to deliver the fluid to the internal surface of the pile body. That is, the manifold may be regarded as an internal manifold, relative to the pile body.

The use of an internal manifold may be of particular benefit in pin pile structures, e.g. pile structures used as part of a foundation structure comprising a jacket structure (e.g. as described in the third aspect below) or other multi-pile foundations, and/or narrower pile structures.

The manifold may comprise a transition portion extending along the pile body in a direction extending away from the pile tip. The transition portion defines a slope for channelling water towards the surface of the pile body proximate to the pile tip. The slope may extend between the manifold and the pile body, and may be configured to guide or channel fluid towards the surface of the pile body. The slope may be any of a convex, concave or straight slope, or may be a combination of said slopes. The transition portion may define one of a chamfer, a fillet or a bevel.

The transition portion defines a transition between the manifold and the surface of the pile body. By using a transition portion, a flow of fluid along the surface of the pile body may be promoted. For example, providing a fillet (generally a concave fillet by virtue of the interior corner otherwise formed between the manifold and the surface of the pile body) may provide a smoother and better regulated flow of fluid from the one or more apertures along the surface of the pile body.

The manifold may be a first manifold comprising a first set of one or more apertures, with the fluid delivery apparatus comprising a second manifold having a second set of one or more apertures configured to deliver the fluid. The second manifold extends circumferentially within an internal surface of the pile body, with the second set of one or more apertures being configured to deliver the fluid to the internal surface of the pile body.

In other words, the fluid delivery apparatus may comprise both an internal manifold and an external manifold.

Delivering fluid to both the internal surface and the external surface of the pile body can provide an increased reduction in the experienced frictional forces, as the pile body is lubricated on two surfaces in contact with the soil of the soil body rather than just one surface.

The internal manifold and the external manifold may each be configured to receive a flow of the fluid from a respective conduit. Additionally or alternatively, the internal manifold and the external manifold may be in fluid communication via the channel formed through the pile body.

A driving shoe may be located at the pile tip. The driving shoe may be referred to as a cutting shoe.

The driving shoe may comprise an external portion and/or an internal portion, referred to as an external driving shoe and an internal driving shoe, respectively. The terms ‘external’ and ‘internal’ refer to a location of the/portions of the driving shoe relative to the wall of the pile body.

The driving shoe generally protrudes outward from the surface of the pile body. The driving shoe may ease insertion of the pile body in the soil body, as it reduces frictional forces experienced by the pile body (above the shoe) during insertion.

The driving shoe may be formed on the surface of the pile body at the pile tip, e.g. by welding. Alternatively, the driving shoe may be formed integrally with the pile body. The driving shoe may, for example, be formed as a thicker section of the pile body to achieve the desired profile of the driving shoe.

The dimensions of the driving shoe may be predetermined based on the soil conditions of the soil body at the location of installation and/or the desired reduction in resistance experienced during pile driving.

The driving shoe may extend, i.e. protrude, at least 40 mm from the surface of the pile body. The driving shoe may extend at least 40 mm, at least 50 mm, at least 60 mm, or at least 70 mm from the surface of the pile body.

The driving shoe may have a length (i.e. height/extension in an axial direction) of between 50 to 200 mm, between 75 to 175 mm, or between 100 to 150 mm.

The fluid delivery apparatus may be located behind and in contact with the driving shoe. In other words, the fluid delivery apparatus/a manifold of the fluid delivery apparatus may be located adjacent and proximate to and directly behind the driving shoe.

By placing the fluid delivery apparatus directly behind the driving shoe, the driving shoe may provide support and/or protection to the fluid delivery apparatus, reducing a likelihood of the fluid delivery apparatus shearing during insertion of the pile body into the soil body. Placing the manifold directly behind the external driving shoe also ensures that the fluid delivery apparatus is placed close to the pile tip to most efficiently deliver fluid to the surface of the pile body.

An external manifold of the fluid delivery apparatus may be located behind and in contact with an external driving shoe.

An internal manifold of the fluid delivery apparatus may be located behind and in contact with an internal driving shoe.

The manifold may be formed integrally with the driving shoe of the pile body. Alternatively, the manifold may be mounted to the driving shoe, e.g. by means welds or bolts.

The pile structure may comprise a plurality of driving shoes. The driving shoes may be distributed along a length of the pile body. Using a plurality of driving shoes may improve the reduction of frictional forces experienced by the pile structure when installed through multiple soil layers.

The pile structure may comprise a plurality of fluid delivery apparatuses. The plurality of fluid delivery apparatus may be distributed along a length of the pile body. Using a plurality of fluid delivery apparatuses may improve the delivery of fluid to lubricate the pile body along its length, especially where the pile structure extends through multiple soil layers during insertion. Each fluid delivery apparatus may be located behind and in contact with a respective driving shoe.

A conduit may extend along a surface of the pile body, wherein the conduit is configured to provide a flow of the fluid to the fluid delivery apparatus.

The conduit is arranged to extend above the soil body. An opening of the conduit may remain above the soil body. A length of the conduit may be chosen such that the opening of the conduit remains above the soil body during and upon installation of the pile structure in the soil body. As such, the opening of the conduit may remain unimpeded and/or clear of any soil or other debris/sediment disturbed during driving of the pile structure. Preferably, the opening of the conduit remains at least 2 m above the soil body upon installation.

The conduit may be or comprise a pipe.

The conduit may be mounted to the pile body e.g. via welding (either directly or indirectly, e.g. via a bracket and/or doubler plate), glue, or one or more brackets arranged to secure the conduit to the pile body. In other words, the conduit may be not formed integrally with the pile body.

During insertion the pile body will experience large forces, e.g. due to the use of an impact hammer or the like. Accordingly, the pile body should be designed to withstand these forces and not structurally fail as a result thereof.

Forming the conduit integrally with the pile body could weaken the structure of the pile structure. Thus, whilst it is possible to design a pile structure having a conduit formed integrally with the pile body, it is not preferred.

Instead, by providing the conduit mounted to the pile body, the conduit may be at least partially isolated from the pile body such that it is shielded from the impact forces experienced during driving of the pile body.

The conduit may be or comprise a half-pipe or other structure mounted to the pile body, defining a channel between itself and the pile body.

The conduit may be configured to provide a flow of the fluid to the fluid delivery apparatus via the channel formed in the pile body. Alternatively, the conduit may be configured to provide a flow of the fluid to the fluid delivery apparatus via the opening formed in the upper surface of the manifold.

The conduit may extend along an internal surface of the pile body. The conduit may be regarded as an internal conduit, relative to the pile body. The conduit may be configured to be in fluid communication with the internal manifold via the opening formed in the upper surface of the internal manifold. The conduit may be configured to be in fluid communication with the external manifold via the channel formed through the pile body. Where an internal and an external manifold are present, the conduit may be configured to deliver the flow of the fluid to the external manifold via the internal manifold (e.g. via the channel).

Alternatively, the conduit may extend along an external surface of the pile body. The conduit may be regarded as an external conduit, relative to the pile body. The conduit may be configured to be in fluid communication with the external manifold via the opening formed in the upper surface of the external manifold. The conduit may be configured to be in fluid communication with the internal manifold via the channel formed through the pile body. Where an internal and an external manifold are present, the conduit may be configured to deliver the flow of the fluid to the internal manifold via the external manifold (e.g. via the channel).

The conduit may be configured to be used in a passive mode of operation in which the conduit is in fluid communication with a body of the fluid located internally of the pile body, and a hydrostatic pressure generated by the body of fluid motivates the flow of the fluid to the fluid delivery apparatus. The passive mode may be a passive mode as described above.

The conduit may be an internal conduit, as described above. The pile body may be configured to contain the body of fluid. The body of fluid may be bounded by the pile body and the soil body. Where the pile body is configured to be installed in a seabed, the body of fluid may have a height/level/depth greater than that of the surrounding sea. Accordingly, a hydrostatic pressure of the body of fluid may be greater than that of the neighbouring sea at the seabed. The body of fluid is preferably a body of seawater.

The passive mode of operation may be particularly effective at delivering fluid to soils that generate a negative pore water pressure in response to insertion of a foreign object. An example of such a soil is one containing glauconite. When the local pore water pressure is negative, the soil acts like a sponge and readily accepts the delivered water (some glauconite samples have been found to have negative pore water pressures in the order of up to 200-400 bar, and accordingly an effective pressure differential may always motivate fluid through the fluid delivery apparatus to such soils). In doing so, the pore water pressure of the soil is made less negative and its shear strength decreases. Less energy is therefore required to drive the pile tip into the soil, easing its insertion.

The passive mode of operation is also particularly advantageous in that, once the level of the body of fluid has been artificially raised, no further energy is required to drive fluid through the fluid delivery apparatus. This mode of operation of the fluid delivery apparatus t is therefore regarded as a passive mode of operation, or passive mode of operation. As the delivery of fluid by the fluid delivery apparatus need only be of a low pressure to lubricate the surfaces of the pile body, there is no need for high-pressure pumping equipment in some soils. The potential energy of the body of fluid is therefore sufficient to motivate the fluid through the fluid delivery apparatus.

The conduit may be configured to be used in an active mode of operation in which the conduit is in flow communication with a pump arranged to motivate the flow of the fluid to the delivery apparatus. The active mode may be an active mode as described above.

In soils of high effective stress, such as those containing high strength clays, a greater pressure differential may be required to deliver fluid to the soil (e.g. to generate an excess pore water pressure). As previously described, the delivery of fluid to clays in this manner may result in the mixing of the clays and the fluid, causing the clay to plasticise and thus be less resistive to insertion of the pile body. The use of the pump may therefore assist in motivating fluid through the fluid delivery apparatus such that it is successfully delivered to soils of high effective stress. This mode of operation may therefore be referred to as an active mode of operation.

The pump may be in flow communication with the conduit either by direct attachment to the conduit, or via an intermediate conduit such as a hose or the like.

The pump may be a submersible pump, and may be configured to provide a flow of seawater or other fluid to the fluid delivery apparatus. Alternatively, the pump is located on a vessel and is arranged to pump a fluid from the vessel.

The pump may be configured to vary the pressure of the fluid delivered by the fluid delivery apparatus.

The conduit may be an internal conduit. In such configurations, the internal conduit may be accessed via a hatch (the hatch may be as described above). The pump may be in flow communication with the conduit via an intermediate conduit passing through the hatch.

The conduit may be arranged behind a driving shoe. That is, the conduit may be located completely behind a footprint/cross-sectional area of the driving shoe. The driving shoe may therefore provide protection to the conduit, e.g. such that it is not damaged or sheared off during insertion of the pile structure into the soil body.

The conduit may protrude further from the pile body than an average protrusion/length of the driving shoe from the pile body. That is, the driving shoe may have a first portion extending a first distance from the pile body. The conduit may extend a third distance from the pile body. The first distance may be smaller than the third distance. The driving shoe may also comprise a second portion extending a second distance from the pile body, wherein the second distance is greater than the third distance. The second portion of the driving shoe may be located in line with the conduit. In other words, the driving shoe may comprise a locally extended portion configured to provide protection to the conduit during insertion of the pile structure into the soil body. Accordingly, the driving shoe may be suitably shaped so as to provide protection to the conduit.

If the conduit is an internal conduit (i.e. located internally relative to the pile body), the conduit may be located behind the internal driving shoe.

If the conduit is an external conduit (i.e. located externally relative to the pile body), the conduit may be located behind the external driving shoe.

The pile structure may comprise a plurality of said conduit.

The pile structure may comprise at least 2, at least 3, at least 4, or at least 5 conduits.

The plurality of said conduit may comprise a plurality of internal and/or external conduits. Each conduit may be distributed circumferentially around the pile body. Providing a plurality of conduits may assist with achieving a desired rate of flow of fluid to the fluid delivery apparatus, and may also provide redundancy should a conduit fracture and/or become non-functional during use.

Viewed from a third aspect of the present invention, there is provided an offshore monopile structure. The offshore monopile structure may be similar to the pile structure of the first aspect or the second aspect. That is, the offshore pile structure of the first aspect and/or of the second aspect may be a monopile.

The offshore monopile structure of the third aspect may have one or more or all of the features (including optional features) of the pile structure of the first and/or second aspects. Thus, the above description may be equally applicable to the offshore monopile structure of the third aspect.

Viewed from a fourth aspect of the present invention, there is provided a foundation structure. The foundation structure comprises: a jacket structure comprising a plurality of legs; and a plurality of pile structures as described in the first and/or second aspect. Each leg of the jacket is mounted to a respective pile structure.

The offshore monopile structure of the fourth aspect may have one or more or all of the features (including optional features) of the pile structures of the first, second and/or third aspects. Thus, the above description may be equally applicable to the foundation structure of the fourth aspect.

Viewed from a fifth aspect of the present invention, there is provided an offshore wind turbine structure. The offshore wind turbine comprises a wind turbine mounted to a pile structure as described in the first, second or third aspect or to a foundation structure as described in the fourth aspect.

The offshore wind turbine of the fifth aspect may have one or more or all of the features (including optional features) of the pile structures of the first, second and/or third aspects and/or of the foundation structure of the fourth aspect. Thus, the above description may be equally applicable to the offshore wind turbine of the fifth aspect.

Viewed from a sixth aspect of the present invention, there is provided a system for installing a pile structure in a soil body. The system comprises: a pile structure as described in any of the first, second or third aspects; and a pile driving hammer.

The system of the sixth aspect may have one or more or all of the features (including optional features) of the pile structures of the first, second and/or third aspects. Thus, the above description may be equally applicable to the system of the sixth aspect.

Viewed from a seventh aspect of the present invention, there is provided a method of installing a pile structure into a soil body. The method comprises: driving a pile tip of a pile body into the soil body using a pile driving tool; and delivering a fluid to a surface of the pile body proximate to the tip. The method also comprises at least one of: delivering the fluid in a direction extending away from the pile tip; and delivering the fluid at a local differential pressure of between 0 and 8 bar.

The soil body may comprise glauconitic sand, glauconite, or high strength clays. These materials may behave as described above. The soil body may be a seabed. The local differential pressure may be a differential pressure relative to the hydrostatic pressure of the sea at the seabed.

The pile driving tool may be a pile driving hammer, impact hammer, vibratory hammer or the like.

The method may comprise delivering the fluid to an internal and/or external surface of the pile body.

The method may comprise driving a flow of the fluid using a hydrostatic pressure head, i.e. driving a flow of the delivered fluid using the force of gravity.

The method may comprise driving a flow of the fluid using a pump.

The method may comprise switching between driving a flow of the fluid using a hydrostatic pressure head and driving a flow of the fluid using a pump.

The method may comprise delivering the fluid intermittently or selectively, depending on formation conditions. The fluid may be delivered concurrently with, and/or in turn with, the step of driving the pile tip.

Alternatively, the method may comprise delivering the fluid constantly, i.e. during/concurrently with the step of driving the pile tip.

The pile structure may be a pile structure as described in any of the first, second or third aspects of the present invention. The method may also comprise the use of the system as described in the sixth aspect of the present invention. Accordingly, the above description may be equally applicable to the method of the seventh aspect, and the method of the seventh aspect may have one or more or all of the features (including optional features) of the aspects aforementioned.

Viewed from an eighth aspect of the present invention, there is provided a method of installing an offshore wind turbine structure in a seabed. The method comprises: a method of installing a pile structure into a seabed as described in the seventh aspect, wherein the soil body is a seabed; and subsequently mounting a wind turbine to the pile structure.

The above description may be equally applicable to the method of the eighth aspect, and the method of the eighth aspect may have one or more or all of the features (including optional features) of the aspects aforementioned.

The wind turbine may be mounted directly to the pile structure.

Alternatively, the wind turbine may be mounted indirectly to the pile structure, e.g. via a foundation structure, a transition piece or the like.

The wind turbine may be understood to comprise at least a hub, nacelle and a plurality of turbine blades. The plurality of turbine blades will be mounted to the hub, which in turn is located at the front of the nacelle. The wind turbine may also comprise a tower. The tower may extend between the pile structure/foundation structure and the nacelle.

Certain preferred embodiments of the present invention will now be described, by way of example only, with reference to the accompanying drawings, in which:

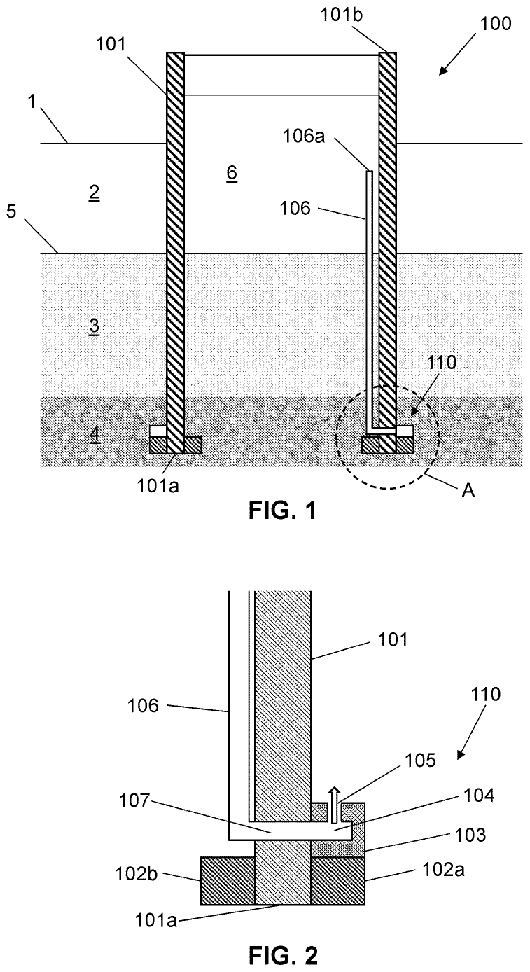

FIG. 1 shows a cross-sectional view of a pile structure installed in a seabed;

FIG. 2 shows a cross-sectional representation of a pile tip of a pile structure;

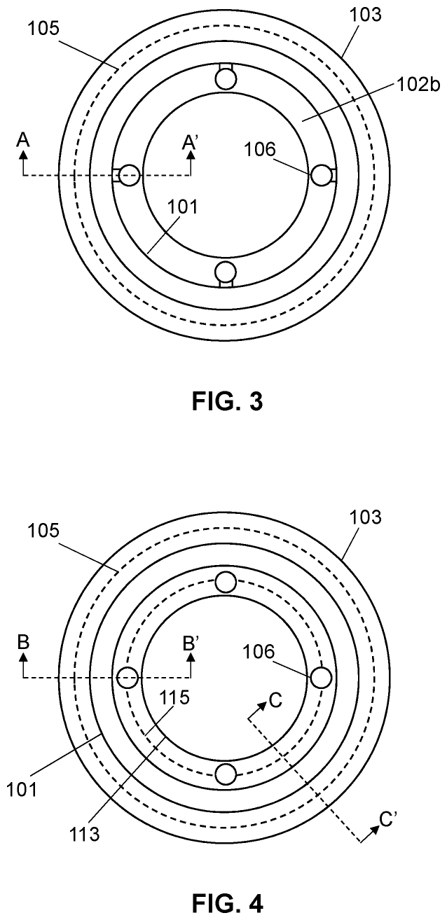

FIG. 3 shows a pile structure in a plan view as viewed from a pile head of the pile structure;

FIG. 4 shows a pile structure in a plan view as viewed from a pile head of the pile structure;

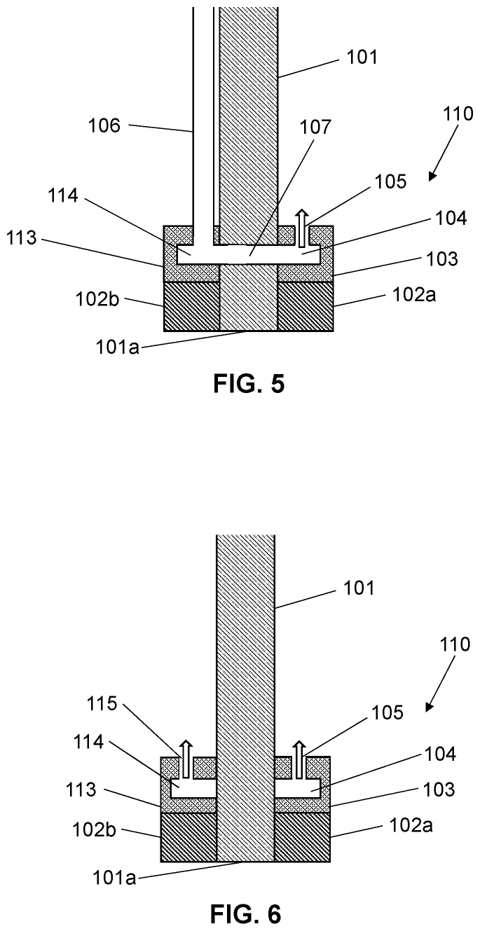

FIG. 5 shows a cross-sectional representation of a pile tip of a pile structure;

FIG. 6 shows a cross-sectional representation of a tip of a pile structure;

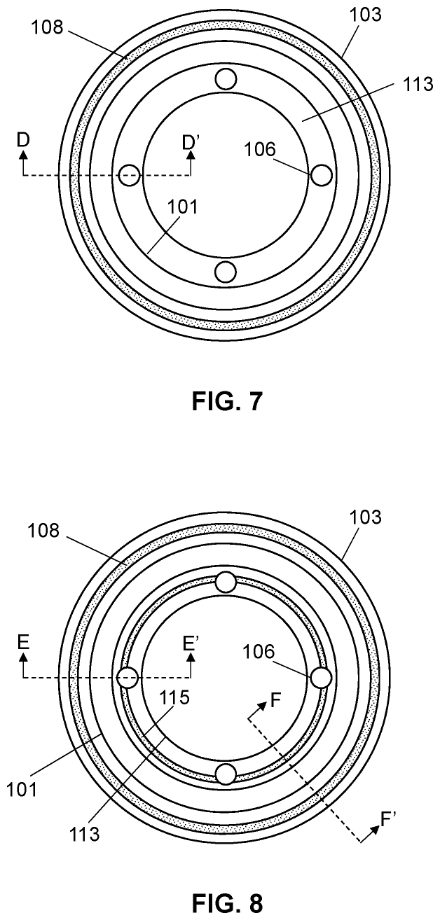

FIG. 7 shows a pile structure in a plan view as viewed from a pile head of the pile structure;

FIG. 8 shows a pile structure in a plan view as viewed from a pile head of the pile structure;

FIG. 9 shows a cross-sectional representation of a pile tip of a pile structure;

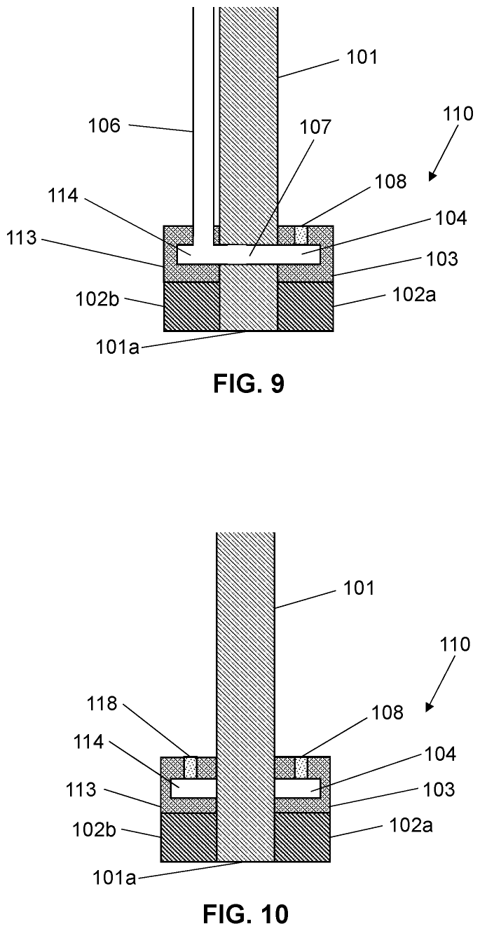

FIG. 10 shows a cross-sectional representation of a pile tip of a pile structure;

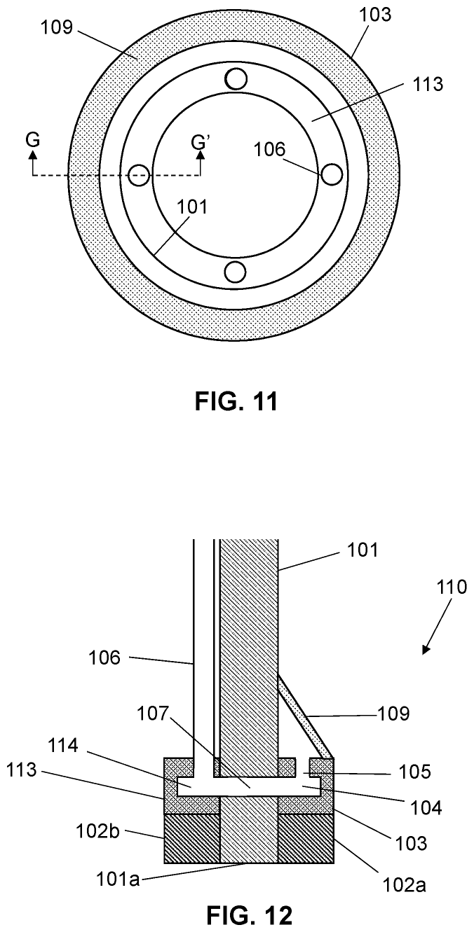

FIG. 11 shows a pile structure in a plan view as viewed from a pile head of the pile structure;

FIG. 12 shows a cross-sectional representation of a pile tip of a pile structure;

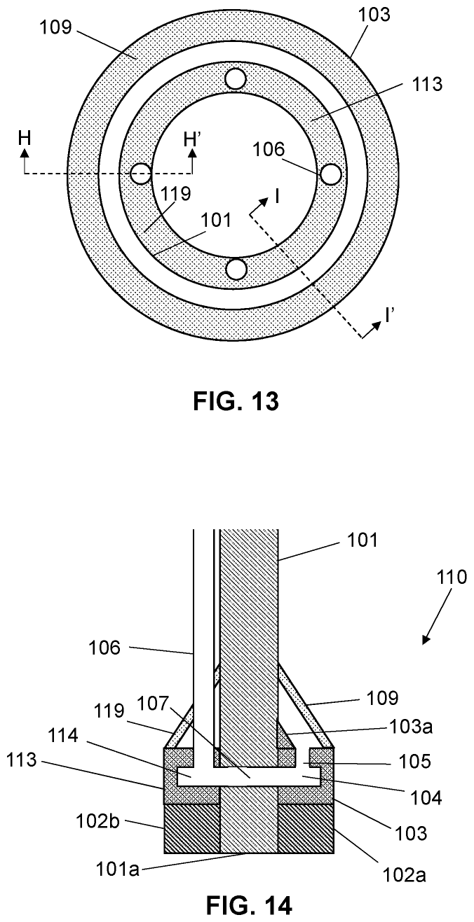

FIG. 13 shows a pile structure in a plan view as viewed from a pile head of the pile structure;

FIG. 14 shows a cross-sectional representation of a pile tip of a pile structure;

FIG. 15 shows a cross-sectional representation of a pile tip of a pile structure;

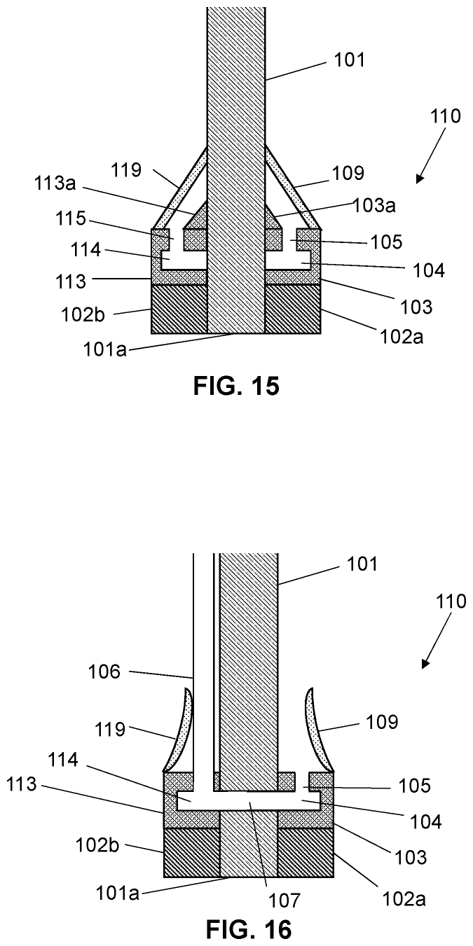

FIG. 16 shows a cross-sectional representation of a pile tip of a pile structure;

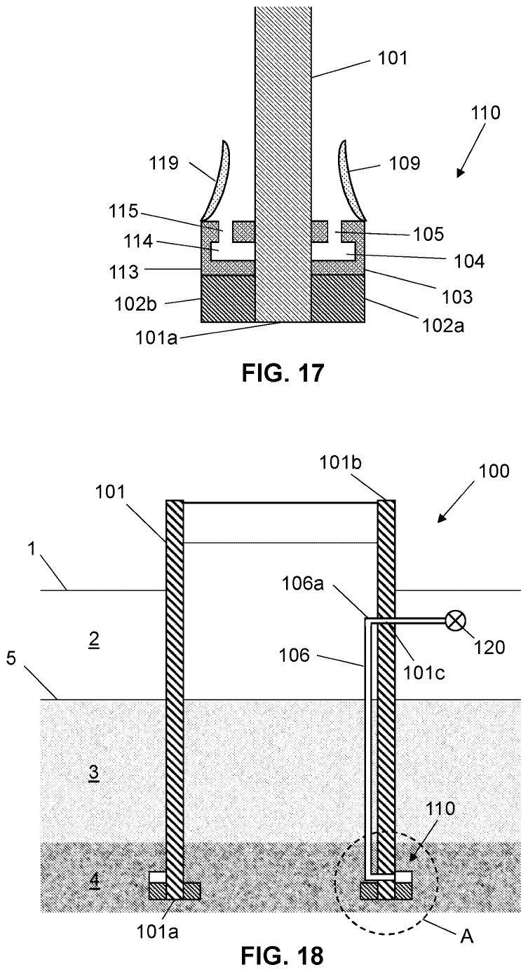

FIG. 17 shows a cross-sectional representation of a pile tip of a pile structure;

FIG. 18 shows a cross-sectional view of a pile structure installed in a seabed; and

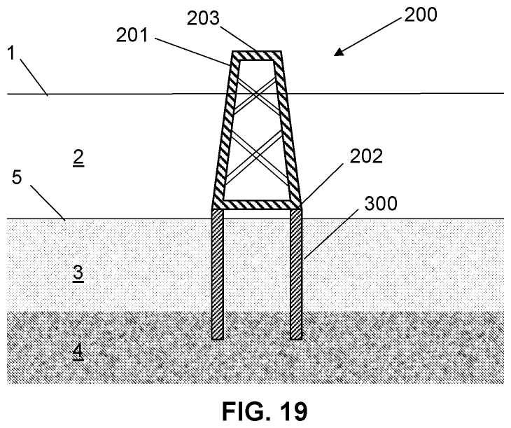

FIG. 19 shows a foundation structure installed in a seabed.

FIG. 1 shows a cross-sectional view of a pile structure 100 for a wind turbine installed in a seabed 5. The seabed 5 comprises various soil layers 3, 4. In the present embodiment, the pile structure 100 is a monopile structure. The pile structure 100 comprises a pile body 101 which, when installed in the seabed 5, extends from below the seabed 5 to above sea-level 1. A distal end of the pile body 101 (located towards the seabed 5), referred to as the pile tip 101a, is configured to be driven into the seabed 5 as shown. The pile tip 101a may also be referred to as the pile toe. A proximal end of the pile body 101 (located towards sea-level 1), referred to as the pile head 101b, is arranged to receive a transition piece (not shown). The transition piece facilitates attachment of the tower of a wind turbine to the pile body 101.

The pile body 101 is a hollow tubular structure which may be referred to as a pipe pile body, pile sleeve, or pile body 101. In the present embodiment, the pile body 101 is a cylindrical structure formed of steel S355, and has a global diameter of 10 m wide. In various embodiments, diameters of up to 15 m or more are contemplated. Diameters of less than 5 m are also contemplated. The diameter of the pile structure 100 can be chosen based on a number of factors including the depth of the sea 2 where the pile structure 100 is to be installed, or the size of the equipment mounted to the pile structure 100 (in this case a wind turbine). The diameter of the pile body 101 is tapered at the top to facilitate the hammer interface, with a central section of the pile body 101 having a constant external diameter.

The pile body 101 is formed of multiple sections which are welded together. Each section is between 2 to 5 m in height. The thickness of the wall of the pile body 101 varies so that the wall of the pile body 101 becomes progressively thicker as the pile body 101 extends towards the seabed 5 (i.e. as the pile body 101 extends from the pile head 101b to the pile tip 101a) and reduces again as the pile body extends towards the pile tip. The lowest section located at the pile tip is the thickest to resist ovalisation/buckling during driving. The lowest section has a wall thickness of between 100 to 120 mm thick. The highest section, which is also the thinnest section in the present embodiment, has a wall thickness of 50 to 70 mm thick. Increasing the wall thickness of the pile body 101 in this manner can minimise stresses and/or fatigue experienced by the pile body 101 during insertion and its subsequent operational lifetime.

In the present embodiment, the portion of the pile body 101 installed in the seabed 5 is 35 m long. The portion of the pile body 101 above the seabed 5 and extending to above sea level 1 is 40 m long.

To insert the pile body 101 into the seabed 5, the pile body 101 is driven into the seabed 5 using a pile driving hammer, also known as an impact-hammer. The pile body 101 is arranged to be struck by the pile driving hammer at the proximal end. Impact of the hammer on the proximal end motivates the pile tip 101a of the pile body 101 into the seabed 5.

The pile tip 101a is shown in further detail in FIG. 2, which provides a close-up representation of detail A of FIG. 1. The pile body 101 comprises a driving shoe 102 which, in the present embodiment, comprises an external driving shoe 102a and an internal driving shoe 102b. In various embodiments, there may be only one of an external driving shoe 102a and an internal driving shoe 102a. It will be appreciated that the terms ‘external’ and ‘internal’ define a location of the/portions of the driving shoe 102 relative to the wall of the pile body 101. The driving shoe 102 may also be referred to as a cutting shoe.

The driving shoe 102 is added after fabrication of the pile body 101 by welding. In other embodiments, the driving shoe can be formed integrally with the pile body 101. The driving shoe 102 has a length of 100 mm, and extends, or protrudes, 50 mm from the wall of the pile body 101.

The inclusion of a driving shoe 102 may ease insertion of the pile body 101 in the seabed 5, as it reduces frictional forces experienced by the pile body 101 during insertion. In this respect, the driving shoe 102 may be effective at cutting into the soil 3, 4 despite it increasing the footprint of the pile body 101 at the pile tip 101a.

The pile driving force required to insert the pile structure 100 into the seabed 5 depends on the size of the pile structure 100. Additionally, if pile structures 100 are desired to be inserted in seabed soils 3, 4 of high effective stress, greater pile driving forces are required to overcome any associated resistive forces experienced during insertion of the pile body 101.

However, to generate greater pile driving forces larger pile driving hammers are needed which are more expensive. Additionally, the use of greater pile driving forces will generate a higher level of noise.

Thus, the pile structure 100 of the present embodiment, and in other embodiments in accordance with the present invention, comprise a fluid delivery apparatus 110. The fluid delivery apparatus 110 is located towards, and preferably substantially at, the pile tip 101a of the pile body 101, and is configured to deliver fluid to a surface of the pile body 101 proximate to the pile tip 101a in a direction extending away from the pile tip 101a (i.e. in a direction back towards the pile head 101b).

By delivering fluid proximate to the pile tip 101a of the pile body 101, the fluid delivery apparatus 110 may act to reduce any effective stresses and/or resistive forces experienced by the pile body 101 during its insertion into the seabed 5. In clay and soils comprising a significant percentage of clay and/or exhibit clay-like properties, the delivered fluid may particularly reduce the undrained shear strength at the soil/pile structure interface. This may reduce the driving force required to successfully install the pile structure 100 in the seabed 5, thus meaning that an amount of noise generated during installation may be reduced and/or smaller pile driving hammers may be used, relative to the size of the pile body 101. Conversely, as less energy is required to motivate the pile structure 100 into the seabed 5, larger pile structures 100 may be installed in the seabed 5 relative to the pile driving force.

The fluid delivery apparatus 110 may act to reduce the experienced effective stresses and/or resistive forces experienced by the pile body 101 during its insertion into the seabed 5 by a plurality of mechanisms.

For example, the delivered fluid may act to lubricate the surface of the pile body 101. This may reduce the frictional forces experienced by the pile body 101 during insertion into the seabed 5.

Additionally, the delivered fluid may act to reduce effective stresses in various soils 3, 4 of the seabed 5 that may resist penetration of the pile tip 101a.

For example, soil layers containing clays may exhibit high effective stresses. The delivery of fluid to these clays may result in mixing of the clays and the fluid, causing the clay to plasticise further beyond the remoulded shear strength and thus be less resistive to insertion of the pile body 101. Additionally, the plasticised clay with an increased water content may form a lubricating layer on the surface of the pile body 101, thus reducing any frictional forces experienced by the pile body 101 during its insertion into the seabed 5.

As well as soil layers containing clays, soil layers containing glauconite (e.g. glauconitic sands) may also exhibit increased resistance to the penetration of the pile tip 101a into the seabed 5. Glauconite, along with some clays, may react to the insertion of objects (such as the pile tip 101a of the pile body 101) by developing a negative pore water pressure. This negative pore pressure develops as a result of low permeability of the sediment, and increases the shear strength of the sediment. By adding fluid to the sediment during insertion of the pile body 101, the negative pore pressure of the material may be made less negative or become positive (i.e. exhibit an excess pore pressure) and the shear strength of the sediment reduced. This can reduce the driving force required to insert the pile body 101 into such soil layers. As these regions of high negative pore pressure also tend to develop in close proximity to the pile body (e.g. within a few centimetres from the pile body), delivery of the fluid to the surface of the pile body is sufficient to reduce the shear strength of these soil layers.

By also delivering the fluid in a direction extending away from the pile tip 101a, the fluid may be more efficiently applied to the surface of the pile body 101 to lubricate it. Having the fluid be delivered in a direction opposite to the direction of insertion of the pile structure 100 also reduces a likelihood of the delivery of fluid from the fluid delivery apparatus 110 being impeded by soil 3, 4 from the seabed 5.

In the present embodiment, seawater is used as the fluid. In other embodiments, however, fresh water or bentonite mud may be used as the fluid. Where water is used as the fluid, the fluid delivery apparatus may be regarded as a ‘water’ delivery apparatus.

Fluid is delivered from the fluid delivery apparatus 110 at a differential pressure of between 0 and 5 bar (0 and 500 kPa) in the present embodiment, said differential pressure being relative to the pressure at sea level or at the pile tip 101a. However, in other embodiments fluid may be delivered at a pressure of between 0 and 8 bar (0 and 800 kPa) or between 0 and 3 bar (0 and 300 kPa). By using a low pressure (i.e. a pressure of less than 10 bar (1 MPa), and of a different order of magnitude to pressure used for processes such as jetting), fluid can be delivered to the surface of the pile body 101 without disturbing the surrounding soil during insertion of the pile structure 100.

For example, for a pile structure 100 having a pile body 101 of approximately 1.5 m in diameter, the volume of fluid delivered per hour may be around 2 m³. This value may scale with the size of the pile body 101 and the form of the fluid delivery apparatus. However, in general the volume of fluid delivered by the fluid delivery apparatus 110 may be between 0 and 10 m³ per hour, or at least of a similar order of magnitude.

In the present embodiment, as shown in detail in FIG. 2, the fluid delivery apparatus 110 is located substantially at, and just behind, the pile tip 101a of the pile body 101. As the pile tip 101a of the pile body 101 may experience the greatest resistive forces during driving of the pile body 101, locating the fluid delivery apparatus 110 at the pile tip 101a may provide the greatest effect in reducing any frictional forces/effective stresses experienced during insertion.

The fluid delivery apparatus 110 comprises a manifold 103 which is an annular manifold extending circumferentially with respect to the pile body 101. The manifold 103 is arranged to lubricate an external surface of the pile body 101, and thus extends circumferentially around the pile body 101. The manifold 103 defines a plenum 104 arranged to receive seawater, and a plurality of apertures 105 distributed around the manifold 103 by which to deliver the seawater. Each aperture 105 may be regarded as a nozzle insofar as it directs a flow of the fluid.

The plurality of apertures 105 are holes or outlets located in a proximally-facing surface of the manifold 103 (i.e. a surface of the manifold 103 facing towards the pile head 101b, in a direction opposite to the direction of insertion of the pile body 101 into the seabed 5). The apertures 105 accordingly deliver the water in the direction they face, as indicated by the arrow in FIG. 2. By placing the plurality of apertures 105 in a proximal (i.e. upper) surface of the manifold 103, water may be more efficiently delivered to the external surface of the pile body 101.

The manifold 103 is located behind (i.e. adjacent and proximate to) and in contact with (i.e. directly behind) the external driving shoe 102a. In this way, the driving shoe 102a may provide protection to the fluid delivery apparatus 110, reducing a likelihood of the fluid delivery apparatus shearing during insertion of the pile body 101 into the seabed 5. Placing the manifold 103 directly behind the external driving shoe 102a also ensures that the fluid delivery apparatus 110 is placed close to the pile tip 101a to most efficiently deliver fluid to the surface of the pile body 101.

As shown in FIGS. 1 and 2, the fluid delivery apparatus 110 is in flow communication with a conduit 106 for delivering fluid to the fluid delivery apparatus 110. In the present embodiment, the conduit is a pipe 106. In the present embodiment, the pipe 106 extends along an internal surface of the pipe body 101, and is in flow communication with the plenum 104 via a channel 107 formed through the pipe body 101.

The pipe 106 extends from the fluid delivery apparatus 110 to above the seabed 5 and is arranged such that, when the pile structure 100 installed to its desired depth in the seabed 5, an opening of the pipe 106 remains above the seabed 5. The opening of the pipe 106 preferably remains at least 2 m above the seabed 5. Accordingly, during insertion of the pile body 101 into the seabed 5, the opening of the pipe 106 remains clear of, and thus unimpeded by, any sediment of the seabed 5 that is disturbed and dispersed in the water flowing into the pipe 106.

The pipe 106 sits behind the internal driving shoe 102b. The internal driving shoe 102b thus provides protection to the pipe 106 during insertion of the pile structure 100 into the seabed 5, in a similar manner to the external driving shoe 102a for the manifold 103.

FIG. 3 shows a plan view of the pile structure 100. The cross-section of FIG. 2 (i.e. detail A), is indicated by line A-A′. The pile structure 100 comprises four pipes 106. Each pipe 106 is identical in function and structure to the pipe 106 described above. Whilst four pipes 106 are shown, any other suitable number of pipes 106 may be used to provide a flow of fluid to the fluid delivery apparatus 110.

The plurality of apertures 105 are distributed circumferentially around the pile body 101 in the upper surface of the manifold 103 (i.e. in the surface facing towards the pile head 101b). The apertures 105 are distributed evenly, with a spacing of 30 mm although in other embodiments other spacing arrangements are contemplated. Each aperture 105 has a diameter of 2 mm.

FIG. 4 shows another embodiment of the present invention. In contrast to the embodiment illustrated in FIGS. 1, 2 and 3, the embodiment illustrated in FIG. 4 comprises both an external manifold 103 as described above and an internal manifold 113.

Like the external manifold 103, the internal manifold 113 comprises a plurality of apertures 115. The apertures 105 are distributed evenly, with a spacing of about 5 mm. However, in other embodiments spacings of 20 to 50 mm or otherwise are contemplated. Each aperture 105 has a diameter of about 2 mm.

FIG. 5 shows a cross-sectional view of the pile body 101 towards the pile tip 101a, across the line B-B′ of FIG. 4. The pipe 106 extends along the inner surface of the pile body 101 and is in flow communication with a plenum 114 defined by the internal manifold 113. The internal manifold 113 is in flow communication with the external manifold 114 via the channel 107 formed through the pile body 107. Channels 107 are formed intermittently circumferentially around the pile body 101, and are preferably formed in line with the pipes 106. However, additional channels 107 may be provided to further facilitate fluid flow from the plenum 114 of the internal manifold 113 to the plenum 104 of the external manifold 103. The channels 107 are preferably evenly spaced around the fluid delivery apparatus 110.

FIG. 6 shows a cross-sectional view of the pile body 101 towards the pile tip 101a, across the line C-C′ of FIG. 4. The plenums 104, 114 respectively defined by the external manifold 103 and the internal manifold 113 extend circumferentially with respect to the pile body 101. Whereas the external manifold 103 and its respective plenum 104 extend circumferentially around the pile body 101, the internal manifold 113 and its respective plenum 114 extend circumferentially within the pile body 101.

The plurality of apertures 115 of the internal manifold 113, like the external manifold 103, are holes or outlets located in a proximally-facing surface of the internal manifold 113. The apertures 115 accordingly deliver the water in the direction they face, as indicated by the arrow in FIG. 6. By placing the plurality of apertures 115 in the proximal surface of the internal manifold 113, water may be more efficiently delivered to the internal surface of the pile body 101.

The internal manifold 113 is located behind and in contact with the internal driving shoe 102b. Both the internal manifold 113 and the pipes 106 that join the internal manifold 113 are thus protected by the internal driving shoe 102b during insertion of the pile body 101 into the seabed 5.

In various embodiments the pile structure 100 may comprise only an internal manifold 113, an external manifold 103, or both an external manifold 103 and an internal manifold 113.

FIG. 7 shows a plan view of an alternative pile structure 100. Rather than comprising a plurality of apertures distributed circumferentially about the manifold 103 as is the case in the pile structures 100 illustrated in FIGS. 3 and 4, the pile structure 100 instead comprises one continuous aperture extending circumferentially about the manifold 103. FIG. 9 represents a cross-sectional view of the pile structure 100 along the line D-D′.

FIG. 8 shoes another plan view of another pile structure 100. The pile structure 100 comprises both an external manifold 103 and an internal manifold 113, wherein each manifold comprises one continuous aperture extending circumferentially thereabout. FIG. 9 represents a cross-sectional view of the pile structure 100 along the line E-E′, and a cross-sectional view of the pile structure along the line F-F′ is provided in FIG. 10.

FIG. 9 illustrates a cross-sectional view of the pile body 101 towards the pile tip 101a. The structure of the pile body 101 and the fluid delivery apparatus 110 is similar to that of FIG. 5, and therefore the discussion of like features will not be repeated.

The fluid delivery apparatus 110 comprises a single continuous aperture extending circumferentially around the manifold 103. The aperture may be equally considered as a slit or a channel. The single continuous aperture is formed in an upper surface of the manifold 103, and is configured to deliver fluid to a surface of the pile body 101 from the plenum 104 of the manifold 104. The single continuous aperture has a depth of about 2 mm. In other embodiments, depths of between 2 and 50 mm are contemplated.

By providing a single continuous aperture circumferentially surrounding the wall of the pile structure 101, fluid may be more evenly and completely delivered to the surface of the pile body 101 proximate to the pile tip 101a. This arrangement may facilitate lubrication of the surface of the pile body 101.

A filter 108 is provided in the single continuous aperture to prevent the ingress of soil into the manifold 103 through the single continuous aperture. The filter 108 is permeable to fluid and therefore allows the delivery of fluid, such as water, from the plenum 104 of the manifold 103 to the surface of the pile body 101 proximate to the pile tip 101a, but is impermeable to soil or other particulate matter above a predetermined grain size. This may prevent the single continuous aperture and the plenum 104 of the manifold 103 from becoming blocked or obstructed during use.

With reference to the pile structure 100 illustrated in FIG. 7 and described above, the fluid delivery apparatus 110 comprises an internal manifold 113. A plenum 114 of the internal manifold 113 is in fluid communication with the pipes 106 and thus receives the fluid. Channels 107 are provided coincident with the pipes 106 and provide the fluid to the external manifold 103. In the present embodiment, channels 107 are also provided at locations between the pipes 106. In other embodiments however, the fluid delivery apparatus 110 may not comprise an internal manifold 113, and may instead comprise one or more pipes 106 feeding fluid directly into the external manifold 104 or indirectly via channels 107.

The internal manifold 113 of the present embodiment does not comprise an aperture to deliver fluid to the internal surface of the pile body 101. Instead, it may function to regulate a flow of the fluid to the external manifold 103. That is, the use of an internal manifold 113 receiving the fluid and a plurality of channels 107 evenly distributed about the fluid delivery apparatus 110 may provide a more even distribution of fluid to the external manifold 103, such that fluid is more evenly delivered from the single continuous aperture of the external manifold to the surface of the pile body 101 proximate to the pile tip 101a.

FIG. 10 illustrates a cross-sectional view of the pile structure 100 of FIG. 8, wherein the fluid delivery apparatus 110 comprises an external manifold 103 and an internal manifold 113. The structure of the pile body 101 and the fluid delivery apparatus 110 is similar to that of FIG. 6, and therefore the discussion of like features will not be repeated.

The internal manifold 113 also comprises a single continuous aperture. The aperture is configured to deliver water to an internal surface of the pile body 101, proximate to the pile tip 104a. The single continuous aperture is provided with a filter 118, of similar function and structure to that of the filter 108 provided for the external manifold 103.

With reference to FIG. 8, pipes 106 provide fluid to the fluid delivery apparatus 110. The pipes 106 are in fluid communication with the internal manifold 113 and may be coincident with the single continuous aperture of the internal manifold 113. In alternative embodiments, the pipes 106 may intersect the single continuous aperture and be provided directly in fluid communication with the plenum 114 of the internal manifold 113.

The filters 108, 118 are sand-epoxy filters, although other filters such as Vyon filters or geotextile filters are contemplated. The permeability of the filter is selected depending on the chosen pressure for delivering the fluid and the desired flow rate of fluid from the fluid delivery apparatus 110.

FIG. 11 shows a plan view of an alternative pile structure 100. The fluid delivery apparatus 110 comprises an internal manifold 113 defining a plenum 114 in fluid communication with a pipe 106. Fluid is provided from the pipe 106 to a plenum 104 of the external manifold 103 via channels 107 extending through the pile body 101. In the present embodiment, there are four pipes 106 and four channels 107 providing fluid to the external manifold 103. In other embodiments however, the fluid delivery apparatus 110 may not comprise an internal manifold 113, and may instead comprise one or more pipes 106 feeding fluid directly into the external manifold 104 or indirectly via channels 107. The external manifold 103 comprises a filter 109. The filter 109 is located downstream of the aperture 105 and extends circumferentially around the pile body 101.

FIG. 12 represents a cross-sectional view of the pile structure 100 of FIG. 11 along the line G-G′. The external manifold 103 comprises a single continuous aperture 105 configured to deliver fluid to the surface of the pile body 101 proximate to the pile tip 101a. In other embodiments however, the external manifold can comprise a plurality of apertures in place of the single continuous aperture. The filter 109 is provided in fluid communication with the aperture 105.

The filter 109 extends along the surface of the pile body 101, and has a pitched or tapered profile relative to the surface of the pile body 101. In the present embodiment the filter 109 is fixed, and thus extends, between an outer edge of the manifold 104 and the surface of the pile body 101 proximate to the pile tip 101a. In other embodiments, the filter 109 may be fixed to any point of the manifold 103 resulting in the aperture(s) 105 being located between the filter 109 and the surface of the pile body 101.

The filter 109 may facilitate the delivery of fluid to the surface of the pile body 101 by channelling the flow of fluid along the surface of the pile body 101, and by wicking a flow of fluid along the surface of the pile body 101. Where the filter 109 is fixed between the manifold 104 and the surface of the pile body 101, the filter 109 may also prevent the ingress of soil or other particulates above a predetermined size into the fluid delivery apparatus 110.

Additionally, the filter 109 may facilitate the delivery of fluid to the soil to the surface of the pile body 101 proximate to the pile tip 101a. During insertion of the pile structure 100, the shape of the driving shoe 102a may result in a cavity or overhang of soil forming above the pile driving shoe 102a otherwise filled with air initially, or with water if below the ground water table. The filter 109 may improve contact between the pile structure 100 and the adjacent soil such that fluid is effectively delivered to the interface between the soil and the pile structure 100, particularly in the region of the surface of the pile body 101 proximal to the pile tip 101a.

The filter 109 is a geotextile filter and is attached to the pile structure 100 using glue. In other embodiments the filter 109 may alternatively be a Vyon filter or a sand-epoxy filter, and/or may be attached using a steel structure with welding and/or glue.

In the present embodiment, the filter 109 is a sheet or of narrow, elongate profile. In other embodiments, the filter 109 may comprise tapered cross-section and sit flush to both the surface of the pile body 101 and to the upper surface of the manifold 103, i.e. against the aperture(s) 105.

FIG. 13 shows a plan view of an alternative pile structure 100. The pile structure 100 is similar to that as illustrated in FIG. 11, except that a filter 119 is provided in fluid communication with the internal manifold 113 in addition to the filter 109 provided in fluid communication with the external manifold 104.

FIG. 14 represents a cross-sectional view of the pile structure 100 of FIG. 13 along the line H-H′. The pipe 106 extends through the filter 119 and through the single continuous aperture, and delivers fluid to the plenum 114 of the internal manifold 113.

FIG. 15 represents a cross-sectional view of the pile structure 100 of FIG. 13 along the line I-I′. The filters 109, 119 are each configured to deliver fluid to the surface of the pile body 101. The structure and function of the filter 109, 119 is similar to that of the filter of FIG. 12, and therefore the discussion of like features will not be repeated.

As illustrated in each of FIGS. 14 and 15, the manifolds 103, 113 each comprise a transition portion 103a, 113a extending along the pile body 101 and located between the apertures 105, 115 and the pile body 101. The transition portions 103a, 113a may help promote the delivery of fluid from the apertures 105, 115 to the adjacent surfaces of the pile body 101. In the present embodiment the transition portions 103a, 113a have a tapered cross-section and define a chamfer. In other embodiments, the transition portions 103a, 113a may have an alternative cross-section, and may define a slope for channelling water towards the surface of the pile body 101, or may define a fillet (i.e. a concave transition for an interior corner) or a bevel extending along the pile body. Transition portions 103a, 113a may be employed in other embodiments.

FIGS. 16 and 17 illustrate a cross-sectional view of an alternative fluid delivery apparatus 110. FIG. 16 represents a cross-sectional view of the pile structure 100 of FIG. 13 along the line H-H′, and FIG. 17 represents a cross-sectional view of the pile structure 100 of FIG. 13 along the line I-l'.

In the present embodiment, the filters 109, 119 are fixed to the external and internal manifolds 104, 113 respectively. The filters 109, 119 are elongate in profile and extend circumferentially around the pile body 101, and are only fixed to the fluid delivery apparatus 110 at one end, said end being proximate to the manifold 103, 113. The filters 109, 119 can therefore be regarded as having a fixed end and a free end. In the present embodiment, the free end is not fixed to the surface of the pile body 101 at all. In some other embodiments, the free end can be periodically or intermittently fixed to the surface of the pile body 101, for instance at every 10 cm or 20 cm, however.

The filters 109, 119 are geotextile filters and are therefore deformable. In use, the filters 109, 119 will trail in a direction opposite to the direction of insertion of the pile body 101 and therefore act as a skirt or a collar for the fluid delivery apparatus 110 extending from the manifold 103, 113 in a direction opposite to the direction of insertion of the pile body 101. The apertures 105, 115 are located between the pile body 101 and the respective filter 109, 119.

The filters 109, 119 act to promote the flow of fluid along the surface of the pile body 101 by channelling the fluid in the desired flow direction. The filters 109, 119 may also serve to provide an increased contact surface area between the fluid delivery apparatus 110 and the surrounding soil during insertion, e.g. in the event that an overhang defining an air gap or a water pocket forms behind the driving shoe 102.

Whilst the embodiments illustrated in each of FIGS. 14 to 17 do not comprise filters 108, 118 occupying the apertures 105, 115, in other embodiments filters 108, 118 occupying the apertures 105, 115 may be provided in combination with filters 109, 119 extending from the manifolds 103, 113.

As shown in FIG. 16, the pipes 106 pass between the internal filter 119 and the pile body 101 to meet the plenum 114 of the internal manifold 113.

In accordance with the above-discussed embodiments, and with reference again to FIG. 1, the pipe 106 is located internally with respect to the pile body 101 and extends along an internal surface of the pile body 101, from the fluid delivery apparatus 110 to above the seabed 106.

To deliver water to the fluid delivery apparatus 110, an opening 106a of the pipe 106 is in communication with a body of seawater 6 located inside the pile body 101. The level of the seawater 6 within the pile body 101 is artificially raised (e.g. via a pump) with respect to the level 1 of the sea 2, such that a hydrostatic pressure head of the body of water drives fluid through the pipe 106 and to the soil 3, 4 of the seabed 5 via the fluid delivery apparatus 110. The level of the seawater 6 in the pile body 101 may be between 5 to 20 m above sea level 1. For every 10 m of elevation gained by the seawater 6 located within the pile body 101 with respect to sea level 1, a hydrostatic pressure of the body of water 6 may be increased by approximately 1 bar (100 kPa). Accordingly, the hydrostatic pressure head of the seawater 6 in fluid communication with the opening 106a of the pipe 106 may generate a greater pressure differential across the fluid delivery apparatus 110, thus motivating fluid through the pipe 106 and the fluid delivery apparatus 110, to be delivered to the soil 4 of the seabed 5.

The above-described fluid delivery arrangement may be particularly effective at delivering fluid to soils that generate a negative pore water pressure in response to insertion of a foreign object. An example of such a soil is one containing glauconite, as previously described. When the pore water pressure is negative, the soil acts like a sponge and readily accepts the delivered water (some glauconite samples have been found to have negative pore water pressures in the order of up to 20-40 bar (2-4 MPa), and accordingly an effective pressure differential may always motivate fluid through the fluid delivery apparatus 110 to such soils). In doing so, the pore water pressure of the soil is made less negative and its shear strength decreases. Less energy is therefore required to drive the pile tip 101a into the soil, easing its insertion.

The above-described fluid delivery arrangement is also particularly advantageous in that, once the level of the body of water 6 has been artificially raised, no further energy is required to drive fluid through the fluid delivery apparatus 110. This fluid delivery arrangement may therefore be regarded as a passive fluid delivery arrangement, or passive mode of operation. As the delivery of fluid by the fluid delivery apparatus 110 need only be of a low pressure to lubricate the surfaces of the pile body 101, there is no need for high-pressure pumping equipment in some soils. The potential energy of the body of water 6 is therefore sufficient to motivate the fluid through the fluid delivery apparatus 110.

In an alternative fluid delivery arrangement, the opening 106a of the pipe 106 is in fluid communication with a pump 120. FIG. 18 illustrates the pile structure 100 in a configuration in which fluid is driven through the fluid delivery apparatus 110 by a pump 120. The pump 120 is in flow communication with the pipe 106 via a hose or other suitable pipe passing through a hatch 101c formed in the wall of the pile body 101.

The pump 120 is a submersible pump suspended from a vessel (not shown) located at sea level 1. In other embodiments, the pump 120 is located on the vessel and is arranged to pump a fluid from the vessel.

The pump 120 is controlled to vary the pressure of the fluid delivered by the fluid delivery apparatus 120. For example, in soils where a negative pore water pressure is developed, a lower water pressure is sufficient to deliver fluid via the fluid delivery apparatus 110.

In soils of high effective stress, such as those containing high strength clays, a greater pressure differential may be required to deliver water to the soil (e.g. to generate an excess pore water pressure). As previously described, the delivery of fluid to clays in this manner may result in the mixing of the clays and the fluid, causing the clay to plasticise and thus be less resistive to insertion of the pile body 101. The use of the pump 120 may therefore assist in motivating fluid through the fluid delivery apparatus 110 such that it is successfully delivered to soils of high effective stress. This fluid delivery arrangement may therefore be referred to as an active fluid delivery arrangement, or active mode of operation.

The hatch 101c is releasable as required, and also functions as a service hatch formed in the wall of the pile body 101. When closed, the hatch 101c is fluid-tight. In the arrangement illustrated in FIG. 1, the hatch 101c is closed. In the present arrangement illustrated in FIG. 18, the hatch 101c is opened. Accordingly, the pile structure 100 is capable of being arranged to be operated in either the passive mode of operation or the active mode of operation, depending on the properties of the soil 3, 4 of the seabed 5 at the desired location of installation of the pile structure 100.

For each of the above-discussed fluid delivery arrangements, the pressure of the delivered fluid is similar to the order of the hydrostatic pressure of the sea 2 at the location of installation of the pile structure 100. For example, pressures of 0 to 5 bar may effectively deliver fluid from the fluid delivery apparatus 110. This is in contrast to the much higher differential pressures used for processes such as jetting, which may require differential pressures of around 10 to 100 bar (1MPa to 10 MPa) to achieve the desired liquification/displacement of soil from the seabed.

By providing lubrication to the pile body 101 at a low differential pressure, the soil 3, 4 of the seabed 5 may be less disturbed during insertion of the pile body 101 into the seabed 5. Accordingly, upon installation of the pile structure 100, the seabed 5 may be able to provide better lateral support to the pile structure 100 and hence improve the stability of the installation.

In various embodiments, the pipe 106 may extend along an external surface of the pipe body 101. The pipe 106 can be protected by an external driving shoe 102a, as described above. The pipe 106 may be in flow communication with an internal manifold 113 via a respective channel 107 formed through the pile body 101, or may be provided in flow communication with a plenum 104 of an external manifold 103. When located externally with respect to the pile body 101, the pipe 106 is configured to be used in combination with the pump 120. The remaining structural and functional features of the pile structure 100 are as described above.

Whilst the pile structure 100 illustrated in FIGS. 1 to 7 is a monopile structure, alternative pile structures are also in accordance with the present invention. For example, FIG. 19 illustrates a foundation structure 200 for an offshore wind turbine installed in a seabed 5. The foundation structure 200 comprises a jacket structure 201 having a plurality of legs 202, and a plurality of pile structures 300. Each leg is 202 is mounted to a respective pile structure 300. The jacket structure 201 is a latticework structure that is located above the seabed 5. A wind turbine can be mounted to a mounting surface 203 of the jacket structure 201, the mounting surface 203 being located above sea level 1. Each pile structure 300 has a structure similar to the pile structure 100 described above. In preferred embodiments, each pile structure 300 comprises an internal manifold and an internally extending pipe. The structures of these components are as described above.

Whilst the embodiments described herein relate to pile structures having tubular pile bodies of annular cross-section, fluid delivery apparatuses of the function and form described above can be modified for use with pile structures having pile bodies of differing shapes and sizes.

1. A pile structure comprising:
a pile body having a pile tip configured to be inserted into a soil body; and
a fluid delivery apparatus configured to deliver a fluid to a surface of the pile body proximate to the pile tip in a direction extending away from the pile tip;
wherein the fluid delivery apparatus is configured to deliver the fluid at a local differential pressure of between 0 and 8 bar.

2. A pile structure as claimed in claim 1, wherein the fluid delivery apparatus is configured to deliver the fluid at a local differential pressure of between 0 and 5 bar.

3. A pile structure as claimed in any claim 1 or 2, wherein the fluid delivery apparatus comprises a manifold having one or more apertures configured to deliver the fluid.

4. A pile structure as claimed in claim 3, wherein the one or more apertures comprise a single continuous aperture extending around the pile body.

5. A pile structure as claimed in claim 3 or 4, wherein the fluid delivery apparatus comprises one or more first filters occupying the one or more apertures, wherein the one or more first filters are configured to be impermeable to soil.

6. A pile structure as claimed in claim 3, 4 or 5, wherein pile body is a tubular pile body, and wherein the manifold is an annular member defining a plenum extending circumferentially with respect to the pile body.

7. A pile structure as claimed in any of claims 3 to 6, wherein the manifold is configured to receive a flow of the fluid via a channel formed through the pile body.

8. A pile structure as claimed in any of claims 3 to 7, wherein the manifold is configured to receive a flow of the fluid via an opening formed in a surface of the manifold facing away from the pile tip.

9. A pile structure as claimed in any of claims 3 to 8, wherein the fluid delivery apparatus comprises a second filter configured to extend from the manifold in a direction opposite to the direction of insertion of the pile tip;
wherein the second filter permeable to the fluid.

10. A pile structure as claimed in claim 9, wherein the second filter is a geotextile fabric filter defining a skirt extending from the manifold, wherein the one or more apertures are located between the skirt and the pile body.

11. A pile structure as claimed in claim 9, wherein the second filter defines a pitched surface extending between the manifold and the pile body, wherein the one or more apertures are covered by the second filter.

12. A pile structure as claimed in any of claims 3 to 11, wherein the manifold comprises a transition portion extending along the pile body in a direction extending away from the pile tip.

13. A pile structure as claimed in any of claims 3 to 12, wherein the manifold extends around an external surface of the pile body and the one or more apertures are configured to deliver the fluid to the external surface of the pile body.

14. A pile structure as claimed in any of claims 3 to 12, wherein the manifold extends around an internal surface of the pile body and the one or more apertures are configured to deliver the fluid to the internal surface of the pile body.

15. A pile structure as claimed in claim 13, wherein the manifold is a first manifold comprising a first set of one or more apertures and the fluid delivery apparatus comprises a second manifold having a second offset of one or more apertures configured to deliver the fluid;
wherein the second manifold extends around an internal surface of the pile body and the second set of one or more apertures are configured to deliver the fluid to the internal surface of the pile body.

16. A pile structure as claimed in any preceding claim, comprising a driving shoe located at the pile tip.

17. A pile structure as claimed in claim 16, wherein the fluid delivery apparatus is located behind and in contact with the driving shoe.

18. A pile structure as claimed in any preceding claim, comprising a conduit extending along a surface of the pile body, wherein the conduit is configured to provide a flow of the fluid to the fluid delivery apparatus.

19. A pile structure as claimed in claim 18, wherein the conduit extends along an internal surface of the pile body.

20. A pile structure as claimed in claim 19, wherein the conduit is configured to be used in a passive mode of operation in which the conduit is in fluid communication with a body of the fluid located internally of the pile body, and a hydrostatic pressure generated by the body of fluid motivates the flow of the fluid to the fluid delivery apparatus.

21. A pile structure as claimed in claim 18, 19 or 20, wherein the conduit is configured to be used in an active mode of operation in which the conduit is in flow communication with a pump arranged to motivate the flow of the fluid to the delivery apparatus.

22. A pile structure as claimed in any of claims 18 to 21, wherein the conduit is arranged behind a driving shoe.

23. A pile structure as claimed in any of claims 18 to 22, comprising a plurality of said conduit.

24. A pile structure as claimed in any preceding claim, wherein the pile body is a tubular pile body,

25. A pile structure as claimed in any preceding claim, wherein the soil body is a seabed.

26. A pile structure as claimed in any preceding claim, wherein the offshore pile structure is an offshore monopile structure.

27. A foundation structure comprising:
a jacket structure comprising a plurality of legs; and
a plurality of pile structures as claimed in any of claims 1 to 25;
wherein each leg of the jacket is mounted to a respective pile structure.

28. An offshore wind turbine structure comprising a wind turbine mounted to a pile structure as claimed in claim 26 or mounted to a foundation structure as claimed in claim 25.

29. A system for installing a pile structure in a soil body, the system comprising:
a pile structure as claimed in any of claims 1 to 26; and
a pile driving hammer.

30. A method of installing a pile structure into a soil body, the method comprising:
driving a pile tip of a pile body into the soil body using a pile driving tool; and
delivering a fluid to a surface of the pile body proximate to the tip;
delivering the fluid in a direction extending away from the pile tip; and
delivering the fluid at a local differential pressure of between 0 and 8 bar.

31. A method as claimed in 30, wherein the pile structure is a pile structure as claimed in any of claim 1 to 26.

32. A pile structure comprising:
a tubular pile body having a pile tip configured to be inserted into a seabed; and
a fluid delivery apparatus configured to deliver a fluid to a surface of the pile body proximate to the pile tip in a direction extending away from the pile tip;
wherein the fluid delivery apparatus is configured to deliver the fluid at a local differential pressure of between 0 and 8 bar.
